(19) United States
(12) Patent Application Publication
(10) Pub. No.: US 2007/0223666 A1
(43) Pub. Date: Sep. 27, 2007

(54) ELECTRONIC EQUIPMENT AND SERVICE PROVIDING PERSONALIZED CALL FEATURES

(76) Inventor: Les Teague, Berkshire (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/277,545

(22) Filed: Mar. 27, 2006

(51) Int. Cl. H04M 1/00

(52) U.S. Cl. 379/162

(57) ABSTRACT

A server provides call hold functions to a communications network through which a call between a user electronic equipment and one or more called/calling devices is routed. The server includes a network interface that connects the server to the communications network, and a controller that is coupled to the communications network via the network interface. The controller is operatively configured to communicate a media object to at least one of the one or more called/calling devices in response to the user electronic equipment placing the call on hold.

### TECHNICAL FIELD OF THE INVENTION

The present invention relates generally to electronic equipment, and more specifically to a service for providing personalized call features to electronic equipment within a communications network.

### DESCRIPTION OF THE RELATED ART

Electronic equipment such as portable electronic devices have been popular for decades, and yet continue to increase in popularity. In the communications area, advances in electronic equipment such as digital telephones, mobile phones, pagers, communicators, electronic organizers, personal digital assistants (PDAs), smartphones, etc. have made it possible for seemingly everyone to own one or more different devices.

In fact, users are increasingly viewing electronic equipment such a mobile phone, etc., as an item of preference. Many different types of electronic equipment today allow the user to customize their experience using the electronic equipment. For example, the user of a mobile phone may select particular wallpapers, screen savers, ring tones, banners, casing colors, etc. Each selection further customizes the mobile phone to the likes and preferences of the user. The mobile phone has therefore increasingly become an extension of the user's own personality.

Despite such past improvements in the user's ability to customize his or her experience, there still have been limitations. For example, the user's selection of wallpaper, ring tone, banners, casing color, etc., personalizes a mobile phone from the perspective of the user. However, such selections do little to share or extend the user's personality with a called or calling device on another end of a call involving the user's mobile phone. The called or calling device is unable to see or hear the user's wallpaper selection, ringtone, etc.

In view of the aforementioned shortcomings associated with existing electronic equipment such as mobile phones, there is a strong need in the art for electronic equipment and service that personalizes the user even with respect to a called/calling device at the other end of a call.

### SUMMARY

According to one aspect of the invention, a server provides call hold functions to a communications network through which a call between a user electronic equipment and one or more called/calling devices is routed. The server includes a network interface that connects the server to the communications network, and a controller that is coupled to the communications network via the network interface. The controller is operatively configured to communicate a media object to at least one of the one or more called/calling devices in response to the user electronic equipment placing the call on hold.

According to another aspect, the controller is operatively configured to communicate the media object to the at least one of the one or more called/calling devices using a same network connection within the communications network upon which the call has been established.

In accordance with another aspect, the controller is operatively configured to stop communicating the media object in response to the user electronic equipment having taken the call off hold.

With yet another aspect, the controller is operative to stream the media object.

In still another aspect, the controller is operative to reproduces the media object as an audio signal when communicating the media object.

According to yet another aspect, the server further includes a library of media objects, and the controller enables a user of the user electronic equipment to select from the library the communicated media object.

According to still another aspect, the server further includes a library of media objects, and the controller communicates the media object selected from among the library of media objects as a function of an identity of the called/calling device to which the media object is communicated.

In accordance with yet another aspect, the server further includes a library of media objects, and the controller communicates the media object selected generally randomly from among the library of media objects.

In accordance with still another aspect, the media object comprises an audio object.

According to another aspect, the media object comprises a visual object.

According to yet another aspect, the media object represents an advertisement.

With yet another aspect, the controller is further configured to provide conference call functions with respect to the call between a user electronic equipment and one or more called/calling devices.

Yet with another aspect, the controller communicates the media object to each of the one or more called/calling devices participating in the conference call.

According to still another aspect, the controller communicates the media object to the at least one of the one or more called/calling devices in response to receiving a request from the user electronic equipment indicating that the call has been placed on hold.

In accordance with another aspect, the request includes criteria based upon which the controller determines the media object to communicate among a library of media objects.

According to still another aspect, a user electronic equipment designed for use in combination with a server as described above is provided. The user electronic equipment includes call circuitry that enables the user electronic equipment to establish a call with a called/calling device, hold circuitry that enables the user electronic equipment to place the call established with the called/calling device on hold, and a controller operative in conjunction with the call circuitry and hold circuitry to communicate a request to the server indicating that the call is placed on hold.

In accordance with another aspect, the request includes criteria based upon which the controller determines the media object to communicate among a library of media objects.

According to another aspect of the invention, a server is presented for providing audio-video voicemail functions to a communications network through which a call between a user electronic equipment and a calling device is routed. The server includes a network interface that connects the server to the communications network. In addition, the server includes a controller that is coupled to the communications network via the network interface. The controller is operatively configured to receive audio-video mail from the calling device when the user electronic equipment does not answer the call.

In yet another aspect, the controller is operatively configured to push user details to the calling device in addition to receiving the audio-video mail.

In still another aspect, the controller is operatively configured to push the audio-video mail to the user electronic equipment.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an exemplary diagram of one or more hold servers provided in a communications network in accordance with an embodiment of the present invention;

FIG. 2A is a perspective view of an exemplary mobile phone in accordance with an embodiment of the present invention;

FIG. 2B is a perspective view of an exemplary mobile phone representing a called/calling device in accordance with an embodiment of the present invention;

FIG. 2C is a perspective view of an exemplary mobile phone representing a called/calling device in accordance with another embodiment of the present invention;

FIG. 2D is a perspective view of an exemplary mobile phone representing a called/calling device in accordance with still another embodiment of the present invention;

FIG. 2E is a perspective view of an exemplary mobile phone representing a called/calling device in accordance with yet another embodiment of the present invention;

FIG. 2F is a perspective view of an exemplary mobile phone representing a called/calling device in accordance with still yet an embodiment of the present invention;

FIG. 3 is a block diagram of an exemplary mobile phone in accordance with an embodiment of the present invention;

FIGS. 4A, 4B and 4C represent exemplary displays on the mobile phone of FIG. 3 for selecting personalized caller hold functions in accordance with an embodiment of the present invention;

FIG. 5 is a block diagram of an exemplary hold server in accordance with an embodiment of the present invention;

FIG. 6 is an exemplary flowchart suitable for programming a mobile phone to request the hold server to communicate selected audio and/or video to a called/calling device while a call is placed on hold;

FIG. 7 is an exemplary flowchart suitable for programming a hold server to communicate selected audio and/or video to a called/calling device in response to a user mobile phone placing a call on hold;

FIG. 8 is an exemplary flowchart suitable for programming a voicemail server to receive and forward audio-video voicemail messages from a calling device to a user's mobile phone; and

FIGS. 9A, 9B and 9C represent exemplary displays on the mobile phone of FIG. 3 for selecting audio-video mail hold functions in accordance with an embodiment of the present invention.

### DETAILED DESCRIPTION OF EMBODIMENTS

The present invention will now be described with reference to the drawings, wherein like reference numerals are used to refer to like elements throughout.

The term “electronic equipment” as referred to herein includes various types of communication equipment such as conventional public switched telephone network (PSTN) equipment (e.g., land phones, etc.) as well as portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like. In the present application, the invention is described primarily in the context of a mobile phone communications network. However, it will be appreciated that the invention is not intended to be limited to a mobile phone communications network. The present invention relates to any type of electronic equipment within a corresponding communications network.

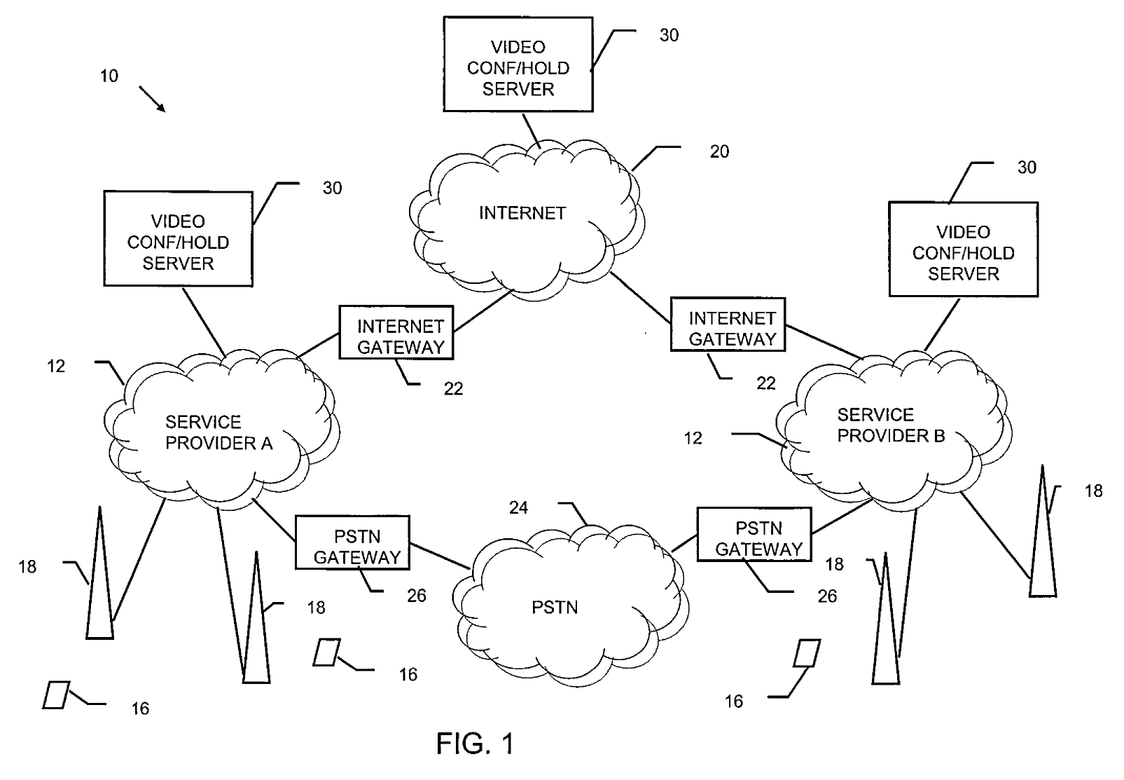

Referring initially to FIG. 1, the present invention is exemplified as part of a mobile phone communications network 10. As an example, the communications network 10 includes one or more mobile phone service providers 12. Each service provider 12 may be any of a variety of different providers offering mobile phone service either currently or in the future. For example, Service Provider A may represent a provider such as Verizon Wireless, etc., and Service Provider B may represent a different provider such as T-Mobile, etc. Each service provider 12 provides wireless communication service to subscribers of the service. FIG. 1 illustrates how each service provider 12 provides wireless communication service to users of mobile phones 16 within the region of the provider 12. Such regions are defined in a cellular wireless communications network, for example, by the geographical locations of cellular towers 18 as is known.

The particular wireless communications networks of the service providers 12 may be expanded via appropriate gateways to include other networks in order to form the overall communications network 10. For example, the service providers 12 may each be linked to the Internet 20 or other wide area network(s) (WAN(s)) via an appropriate gateway 22. In addition, or in the alternative, each of the service providers 12 may be linked to the conventional PSTN 24 by way of an appropriate gateway 26. As is conventional, the mobile phone communications network 10 of FIG. 1 allows a mobile phone 16 to call or receive calls from another mobile phone via communications routed through the service provider network(s), the PSTN, the Internet, etc., or any combination thereof. Thus, the communications network 10 of the present invention can have virtually any structure represented by one or more networks alone or in combination.

In accordance with the present invention, one or more video conference and/or hold servers 30 are included within the communications network 10. The servers 30 may be included directly within the network of the service providers 12, or accessible to the service providers via the Internet 20, the PSTN 24, etc. Voice and data communications between the different individual networks 12, 20, 24 and the mobile phones 16 may be carried out using conventional communication protocols currently available within mobile networks (e.g., as part of conventional voice communications, web access, video casting, etc.).

As will be described in more detail below, the servers 30 are each capable of providing videoconferencing and/or call hold functions within the communications network 10. According to one embodiment, the user of a mobile phone 16 may place a call on hold between the mobile phone 16 and a called/calling device in the form of another mobile phone 16 (or other type of electronic equipment). By placing the call on hold, the mobile phone 16 of the user transmits a request to a corresponding server 30 requesting that the server 30 transmit to the called/calling device(s) a personalized media object while the call is on hold. As referred to herein, a “media object” can be any audio and/or visual data file or reproduction thereof. The audio may be a personalized message, a favorite song, a favorite comedy routine, etc. The visual data file may be a video clip, still image, slideshow of images, etc.

For example, the server 30 may be configured to stream a media object to the called/calling device via the same network connection upon which the call has been established. This allows the called/calling device to reproduce the media object selected by the user of the mobile phone 16 and thereby enjoy listening to and/or watching a personalized call hold message while waiting for the user of the mobile phone 16 to take the call off hold. The media object provided by the server 30 thereby becomes a further extension of the personality of the user of the mobile phone 16.

According to another example, in the case of an audio-based media object, the server 30 may simply reproduce the media object and communicate the audio message to the called/calling device as part of the standard voice communications. This allows a called/calling device to receive the audio message without necessarily having to reproduce the media object itself. Of course, with the relatively recent introduction of 3G technology and the ongoing improvements of mobile phones, many mobile phones are already capable, and soon almost every mobile phone will be capable of receiving and reproducing media objects whether the media objects be provided as complete digital files, streamed, etc.

In accordance with still another aspect of the invention, the servers 30 may each be capable of receiving combination audio-video mail messages. For example, if a device within the network 10 calls a user mobile phone 16 and the user is unable to answer, the server 30 receives a message comprising both audio and video data. The server 30 can subsequently push details regarding the user to the called/calling device using known push technology previously associated with email functions using mobile phones. Such user details again are useful for extending the personality of the user. Moreover, the server 30 can push the audio-video mail to the mobile phone 16 of the user so as to be available promptly to the user.

Further, the servers 30 may each be capable of providing conventional video conference capabilities. As is known, a video conference server provided within the service provider 12 network or elsewhere can be utilized to combine three or more mobile phones 16 or other called/calling devices into a common conference call. Moreover, with the advent of 3G technology and increased data transfer rates, video conference calls including both audio and video are now available.

For sake of convenience, the servers 30 described herein are each capable of serving as a hold server for call hold functions, an audio-video mail server for audio-video mail functions and a video conference server for videoconference functions. However, those having ordinary skill in the art will appreciate that one or more dedicated server(s) could instead handle the respective functions without departing from the scope of the invention.

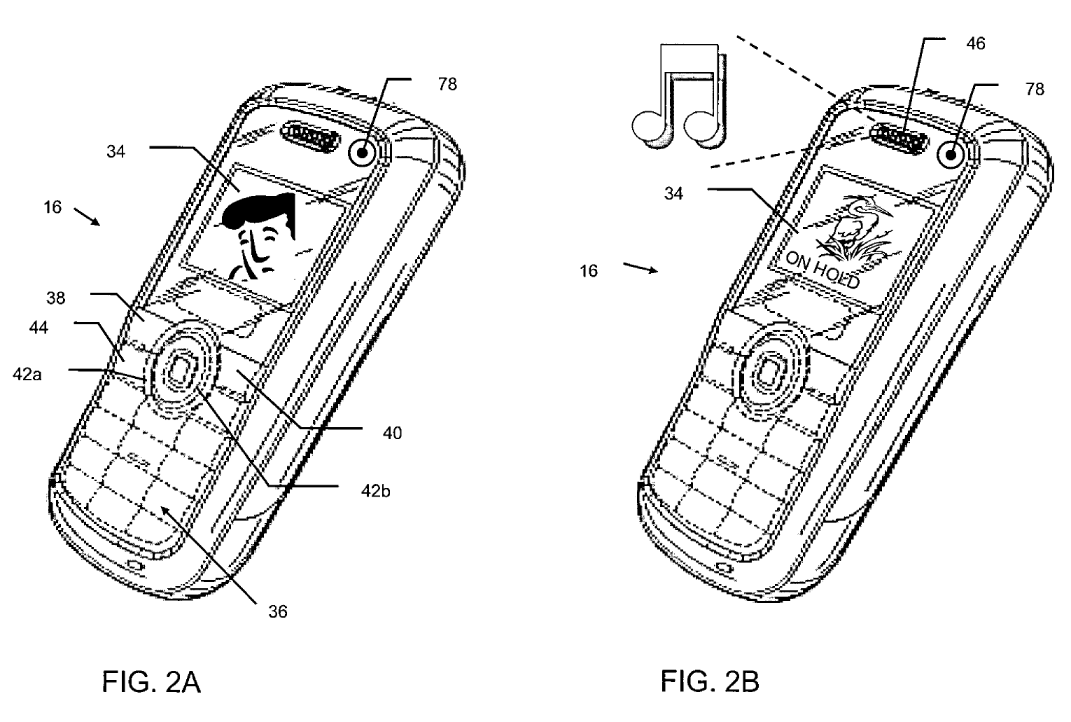

FIG. 2A illustrates a mobile phone 16 in accordance with the present invention. The mobile phone 16 as described herein can represent both a user mobile phone 16 in accordance with the present invention, or a called or calling mobile phone 16 between which a call with the user mobile phone 16 is established. Those having ordinary skill in the art will find it readily apparent from the context of the description provided herein whether the mobile phone 16 is being referred to as a user mobile phone 16 or a called/calling device mobile phone 16. Moreover, although the mobile phone 16 of the present invention may have the features described herein, those with ordinary skill will be appreciate that the called/calling device mobile phone 16 need not necessarily have the same features. A single type mobile phone is described herein merely for convenience.

The mobile phone 16 as shown in FIG. 2A has a “brick” or “block” design type housing, but it will be appreciated that other type housings such as clamshell or slide-type housings may be utilized without departing from the scope of the invention.

The mobile phone 16 includes a display 34 and keypad 36. As is conventional, the display 34 displays information to a user such as operating state, time, phone numbers, contact information, various navigational menus, etc., which enable the user to utilize the various features of the mobile phone 16. Similarly, the keypad 36 may be conventional in that it provides for a variety of user input operations. For example, the keypad 36 typically includes alphanumeric keys for allowing entry of alphanumeric information such as telephone numbers, phone lists, contact information, notes, etc. In addition, the keypad 36 typically includes special function keys such as a “call send” key 38 for initiating or answering a call, and a “call end” key 40 for ending, or “hanging up” a call. Special function keys may also include menu navigation keys 42a, 42b and 42c, for example, for navigating through a menu displayed on the display 34 to select different phone functions, profiles, settings, etc., as is conventional. Other keys included in the keypad 36 may include a volume key (not shown), on/off power key (also not shown), as well as various other keys such as a web browser launch key, camera key, etc.

The mobile phone keypad 36 also includes a “hold” function key 44 for placing a call on hold. As is well known, sometimes the user of the mobile phone 16 desires to place the party or parties at the other end of a call on hold. By placing a call on “hold”, the called/calling device(s) at the other end of a conventional voice call do not receive audio from the user's mobile phone 16. In the case of a video phone call in which both audio and video signals are exchanged between the user's mobile phone 16 and the called/calling device(s), by placing a call on “hold” at least one or both of the audio and video from the user's mobile phone 16 is not sent to the called/calling device(s). In other words, the called/calling device(s) either receive video but no audio from the user's mobile phone 16; receive audio but no video; or do not receive audio or video.

In the embodiment of FIG. 2A the mobile phone 16 includes a dedicated “hold” function key 44 that toggles a call between “on hold” and “off hold”. Alternatively, the mobile phone 16 may associate more than one function with a given key on the keypad 36. For example, mobile phones commonly have a hold feature associated with the “call send” key 38. When making a call, the user enters a phone number and presses the “call send” key 38. When receiving an incoming call, the “call send” key 38 may be programmed to act as a “call answer” key. When participating in a call, the “call send” key 38 may serve as a “call hold” key for placing the call on hold. A user may wish to place a call on hold for any of a variety of known reasons. For example, the user may be on a call when another incoming call arrives. By pressing a dedicated hold key 44 the user may place the current call on hold and then answer the new incoming call. Alternatively, in the case of a multifunction hold key the user may press the “call send” key 38 once to place the current call on hold and a second time to answer the new incoming call.

Those having ordinary skill in the art will appreciate that the particular mechanism utilized by a user to place a call on hold is not germane to the invention. The mobile phone 16 simply requires a means for allowing a user to place a call on hold. The specific form or format of the key(s) for placing a call on hold is not intended to limit the scope of the invention.

In the particular embodiment of FIG. 2A, the mobile phone 16 includes the display 34 and separate keypad 36. In an alternative embodiment, the display 34 may comprise a touchscreen which itself includes one or more keys. In yet another embodiment, the display 34 may comprise a touchscreen that includes all or substantially all of the keys used to operate the phone 16 so as to include a very limited keypad 36 or no keypad 36 at all. As will be appreciated, the particular form and function of the keys included in the keypad 36 or touchscreen/display 34 are not germane to the invention in its broadest sense.

The features of the present invention are described herein in the context of a mobile phone 16 suitable for carrying out video phone calls. For example, FIG. 2A illustrates how a video of a person at the called/calling device is transmitted over the communications network 10 and displayed by the mobile phone 16 of the user in accordance with the present invention. Similarly, the called/calling device will display a video of the user of the mobile phone 16. As is known, the mobile phone 16 is capable of sending and receiving video as well as audio during a call with a called/calling device. Moreover, the mobile phone 16 is capable of participating in video conference calls as is known. The particular technologies for communicating audio and video in both conference call and non-conference call settings are considered conventional. Accordingly, a detailed description of such technologies has been omitted for sake of brevity. On the other hand, many of the features of the present invention may be enjoyed even simply with traditional voice communications. In the broadest sense, the present invention is not intended to be limited in scope to any particular form of communications, e.g., whether audio and/or video.

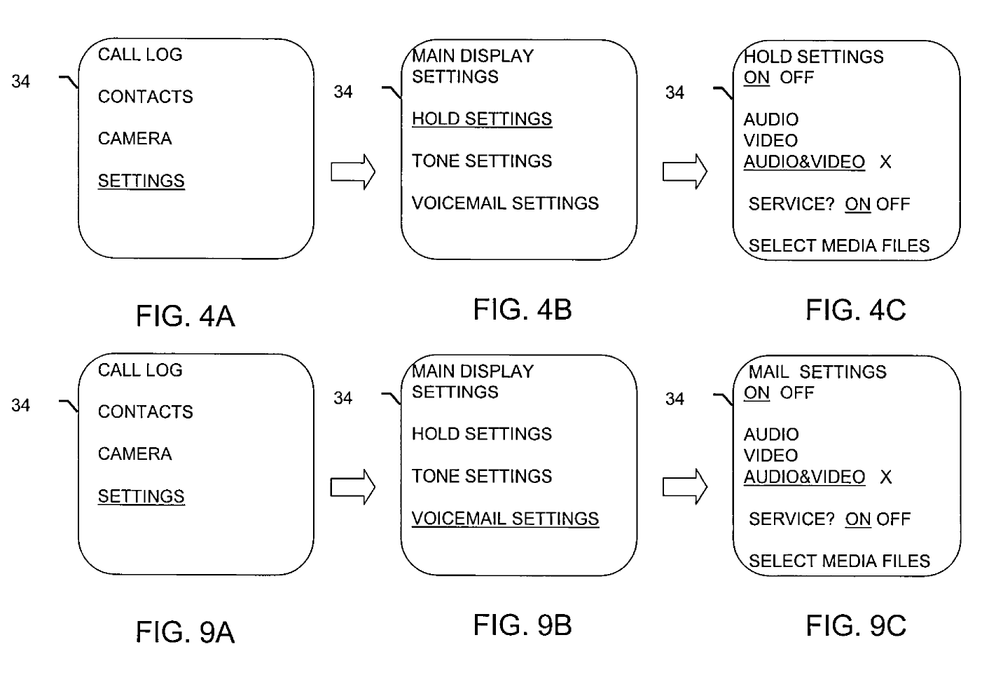

FIG. 2B illustrates a mobile phone 16, but in this case the mobile phone 16 constitutes the called/calling device at the other end of a call with a user's mobile phone 16 in accordance with the present invention. FIG. 2B represents circumstances whereby the user's mobile phone 16 has placed a call on hold. As is described below with respect to FIG. 6, the user's mobile phone 16 when desiring to place a call on hold sends a request to one of the hold servers 30. The request prompts the hold server 30 to send a media object to the called/calling mobile phone 16. In the exemplary embodiment of FIG. 2B, the hold server 30 provides a media object including audio such as a song preselected by the user of the mobile phone requesting the hold. The audio is reproduced by the mobile phone through the speaker 46 as shown, for example. In addition, the media object provided by the hold server 30 can include a visual portion such as one or more still images or a video shown on the display 34. As a consequence, when the user of the mobile phone 16 places a call on hold, the mobile phone 16 of the party at the other end of the call will be able to enjoy the audio and/or video images provided by the hold server 30. Thus, the audio and video becomes an extension of the personality of the user of the mobile phone 16 that placed the call on hold. As is shown in FIG. 2B, the display 34 also may display a small “On Hold” message to visually indicate that the call has been placed on hold.

FIG. 2C illustrates another embodiment of the invention whereby the mobile phone 16 at the other end of the call placed on hold receives and reproduces a form of corporate logo or other type advertisement. For example, FIG. 2C represents a brief commercial video displayed on the display 34 together with commercial jingle reproduced via the speaker 46. Thus, sales professionals are able to provide to callers on the other end a brief promotion while they place a call on hold.

FIG. 2D illustrates a simple embodiment whereby a media object containing only an audio portion is provided to the called/calling device by the hold server 30.

FIGS. 2E and 2F illustrate an embodiment of the mobile phone 16 with video conference capability. In FIG. 2E, the display 34 is divided into different sections with each section providing an image of one of the participants at the other end of the video conference. FIG. 2F illustrates the case where one of the participants (e.g., in the lower right quadrant) places the call on hold from his mobile phone 16. As a result, the hold server 30 provides a media object to the called/calling devices of the other participants (e.g., the mobile phone 16 in FIG. 2F). Again, the media object may include audio, still image(s) and/or video as represented in FIG. 2F. In the case of a video conference call, however, the user of the mobile phone 16 requesting the hold may prefer not to request a media object including audio as the audio may be distracting to the other participants who may prefer to continue the video conference amongst themselves.

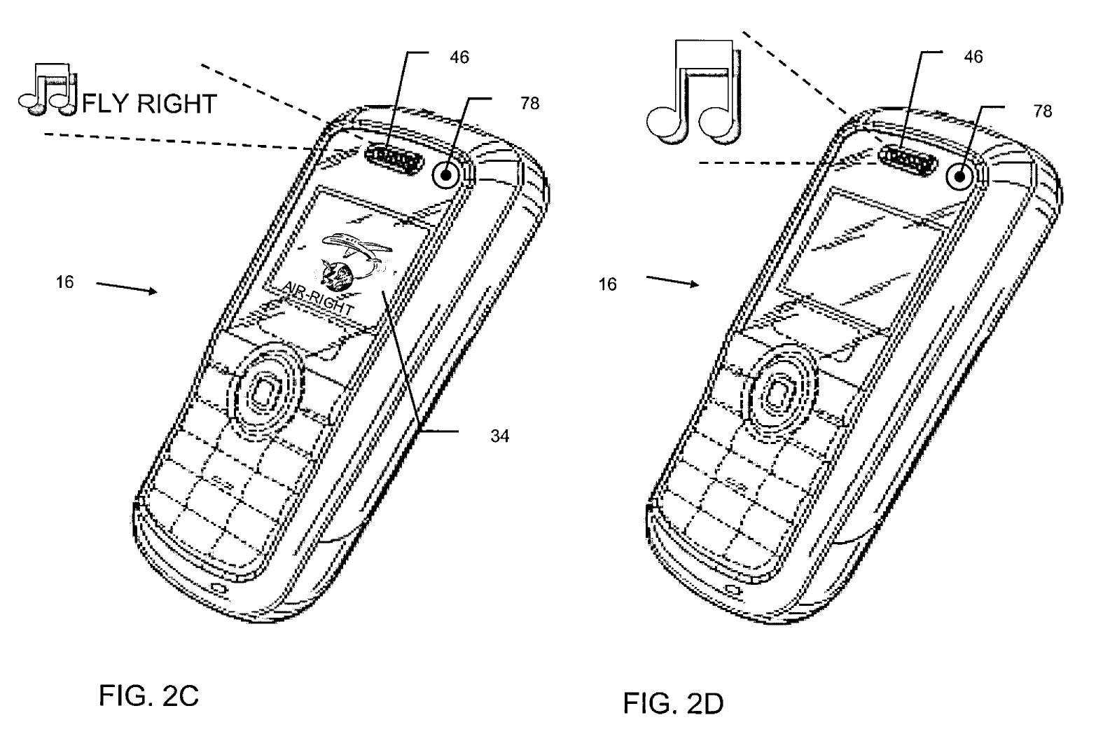

FIG. 3 represents a functional block diagram of the mobile phone 16 in accordance with the invention. The construction of the mobile phone 16 is generally conventional with the exception of the hold and voicemail functions. Preferably, the hold and voicemail functions are implemented primarily via application software within the mobile phone 16. However, it will be apparent to those having ordinary skill in the art that such operation can be carried out via primarily software, hardware, firmware, or combinations thereof, without departing from the scope of the invention.

The mobile phone 16 includes a primary control circuit 48 that is configured to carry out overall control of the functions and operations of the mobile phone 16. The control circuit 48 may include a CPU, microcontroller, or microprocessor, etc., collectively referred to herein simply as a CPU 50. The CPU 50 executes code stored in memory within the control circuit 48 (not shown) and/or in a separate memory 52 in order to carry out conventional operation of the mobile phone functions 54 within the mobile phone 16. In addition, however, the CPU 50 executes code stored in the memory 52 in accordance with the present invention in order to perform a hold function 56, media player function 58 and voicemail function 60.

As is explained in more detail below, the hold function 56 enables a user of the mobile phone 16 to place a call on hold. In addition, the hold function 56 serves to send a request to the hold server 30 requesting that a media object or objects be sent to the called/calling devices at the other end of the call. Moreover, the hold function 56 enables the user to take the call off hold and send a request to the hold server 30 that conventional communications resume.

The media player function 58 serves to play media objects stored within the mobile phone 16 as is conventional. In addition, however, the media player function 58 itself may be used to provide a media object to one or more called/calling devices at the other end of a call when the call is placed on hold. However, this aspect of the invention is the subject of another application filed by applicant.

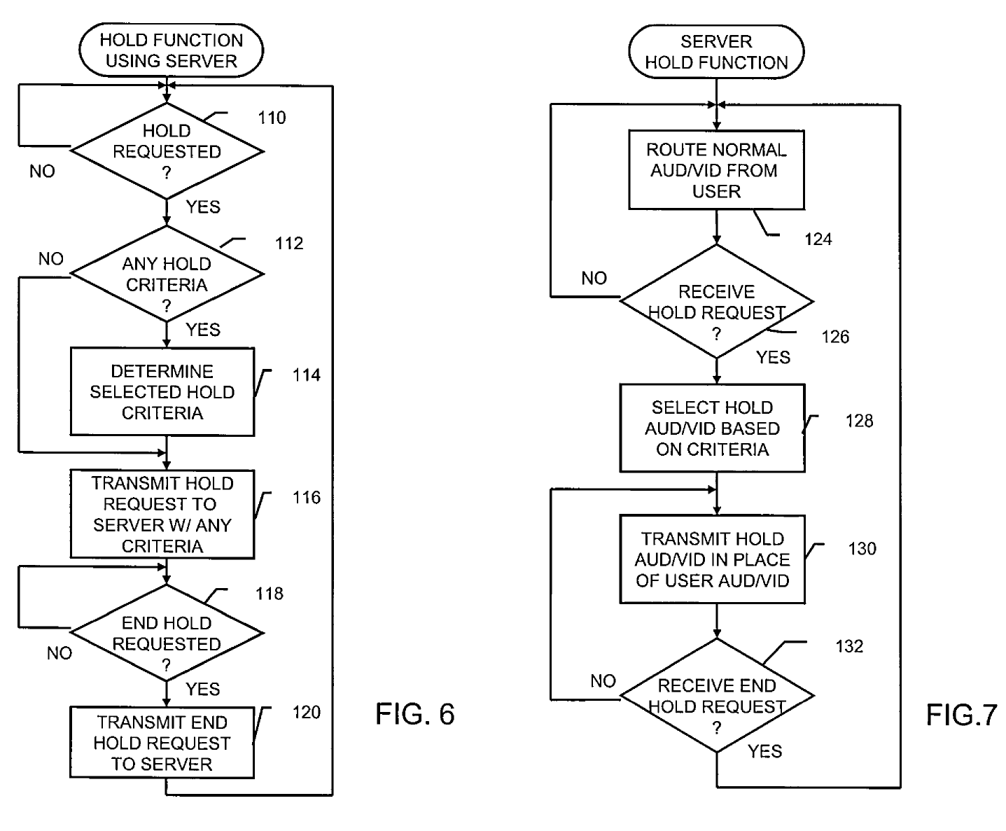

The voicemail function 60 serves to provide audio-video mail in accordance with the invention as discussed below in relation to FIG. 8.

The mobile phone 16 further may include a media library 62. The media library 62 represents a storage medium that stores various media objects in the form of audio files, video files, picture/image files, etc. The storage medium preferably is a non-volatile memory such as a large capacity flash memory or micro-hard drive, each of which are well known in personal media players. In a more limited context, the media library 62 may be represented by a relatively small capacity compact disk (CD), mini-disk, flash card, etc., each of which may be inserted into the mobile phone 16 for reproduction of the media objects thereon. Alternatively, media object(s) also may reside on remote storage. For example, the media objects may reside on a remote server also accessible by the mobile phone 16 via a wireless Internet connection.

A person having ordinary skill in the art of computer programming and specifically in applications programming for mobile phones will consider it obvious in view of the description provided herein how to program a mobile phone 16 to operate and carry out the functions described herein. Accordingly, details as to the specific programming code have been left out for sake of brevity. Also, while the hold function 56 and voicemail function 60 are carried out via the CPU 50 and application software in the memory 44 in accordance with a preferred embodiment of the invention, such functions could also be carried out via dedicated hardware, firmware, software, or combinations thereof, without departing from the scope of the invention.

Continuing to refer to FIG. 3, the mobile phone 16 includes an antenna 64 coupled to a radio circuit 66. The radio circuit 66 includes a radio frequency transmitter and receiver for transmitting and receiving signals via the antenna 64 as is conventional. The mobile phone 16 further includes an audio processing circuit 68 for processing the audio signal transmitted by/received from the radio circuit 66. In addition, the audio processing circuit 68 serves to process the audio signal provided by the control circuit 48 during playback of media objects. Coupled to the audio processing circuit 68 are the aforementioned speaker 46, and a microphone 70 which enable a user to listen and speak via the mobile phone 10 as is conventional. In addition, a headphone jack 72 coupled to the audio processing circuit 68 is provided. This allows a headset to be connected to the mobile phone 16.

The mobile phone 16 also includes a video signal processing circuit 76 as shown in FIG. 3. The video signal processing circuit allows the mobile phone 16 to reproduce media objects including images and/or videos on the display 34. Moreover, the video signal processing allows a still images and/or videos from the mobile phone 16 to be captured via a camera 78 included in the phone 16. The camera 78 is preferably mounted on the face of the mobile phone 16 as shown in FIGS. 2A thru 2F so as to be capable of capturing an image of the user. During video conference calls, the camera 78 captures an image that is then communicated along with the audio to the video conference server 30 to the called/calling devices on the other end of the call.

The mobile phone 16 also includes the aforementioned display 34, keypad 36, and specifically the “hold key” 44, coupled to the control circuit 48. The mobile phone 16 further includes an I/O interface 80. The I/O interface 80 may be in the form of any one of many typical mobile phone I/O interfaces, such as a multi-element connector at the base of the mobile phone 16. As is typical, the I/O interface 80 may be used to couple the mobile phone 16 to a battery charger to charge a power supply unit 82 within the mobile phone 10. In addition, or in the alternative, the I/O interface 80 may serve to connect the mobile phone 16 to a wired personal hands-free adaptor (not shown) or Bluetooth adaptor (also not shown) for use with a Bluetooth-based hands-free adaptor. Further, the I/O interface 80 may serve to connect the mobile phone 16 to a personal computer or other device via a data cable, etc. As another alternative, the I/O interface 80 may serve to connect the mobile phone 16 to a docking station including an audio amplifier, speakers and/or video display to allow for enhanced viewing/listening of the media objects as part of the media player function.

Additionally, the mobile phone 16 in accordance with the present invention includes a hold on/off detector 84. However, this aspect of the invention is also the subject of another application filed by the applicant.

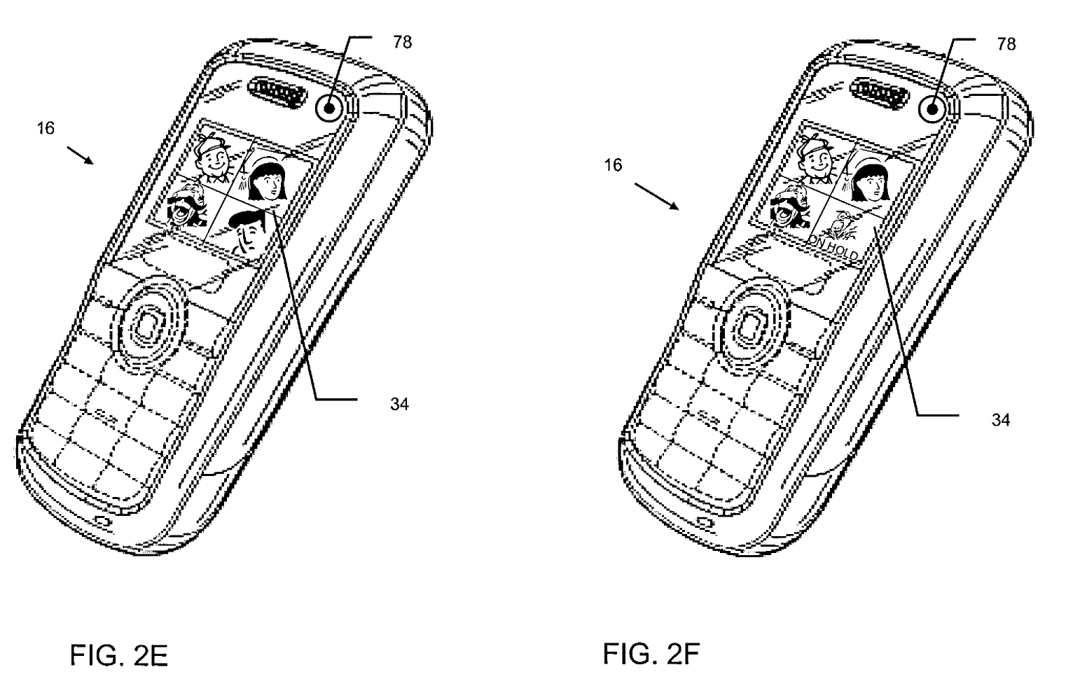

Referring now to FIGS. 4A, 4B and 4C, an exemplary user interface presented on the display 34 is shown illustrating how a user may make appropriate selections in accordance with the invention. Suppose the user of the mobile phone 16 wishes to activate the call hold functions of the present invention. The user may press a menu button on the mobile phone 16 and be presented with the display of menu selections as represented in FIG. 4A. The user may selection the “Settings” selection in order to proceed to the next menu as represented in FIG. 4B. In FIG. 4B, the user is presented with the option of adjusting the “hold settings”. By selecting “hold settings”, the user is then presented with the display represented in FIG. 4C. The user may then customize the hold settings using conventional principles as used with respect to selecting ring tones, wallpaper, etc. For example, FIG. 4C illustrates how the user is presented with the option of turning the call hold features on or off. In addition, the user can select whether the media objects delivered to the called/calling devices at the other end of a held call receive audio, video, or combined audio and video objects. Moreover, the user is presented with the option of whether hold service via the hold server 30 is utilized. As noted in the present application, the hold servers 30 may be used to communicate one or more media objects to the called/calling devices at the other end of a held call. In this case, the user would select that the service be “on”. As covered in a related application filed by the applicant, however, the mobile phone 16 itself may provide the media objects to the called/calling devices. In such case, the user would select that the service be “off”, yet the hold function mentioned above remain “on”.

The user of the mobile phone 16 may also select personalized media files as represented in FIG. 4C. Although not shown, the user may select particular songs, personal videos, advertisements, promotional videos, etc. to be communicated to the called/calling devices at the other end of a held call. Moreover, the user may select to input different criteria to be used in conjunction with the selection of the particular media objects to be communicated. For example, the user may be presented with an option to associate specific media objects (e.g., songs) based on the identification of the called/calling party. Alternatively, the user may be presented with an option to randomly select media objects to be communicated, for example.

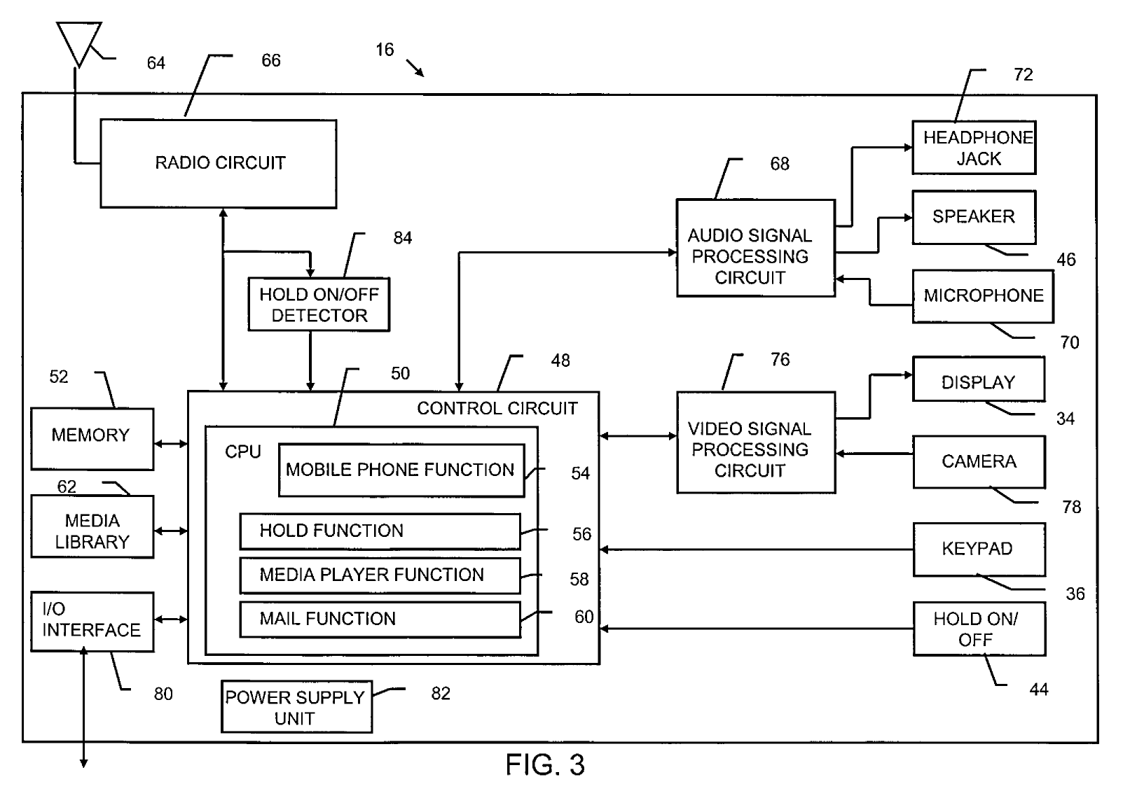

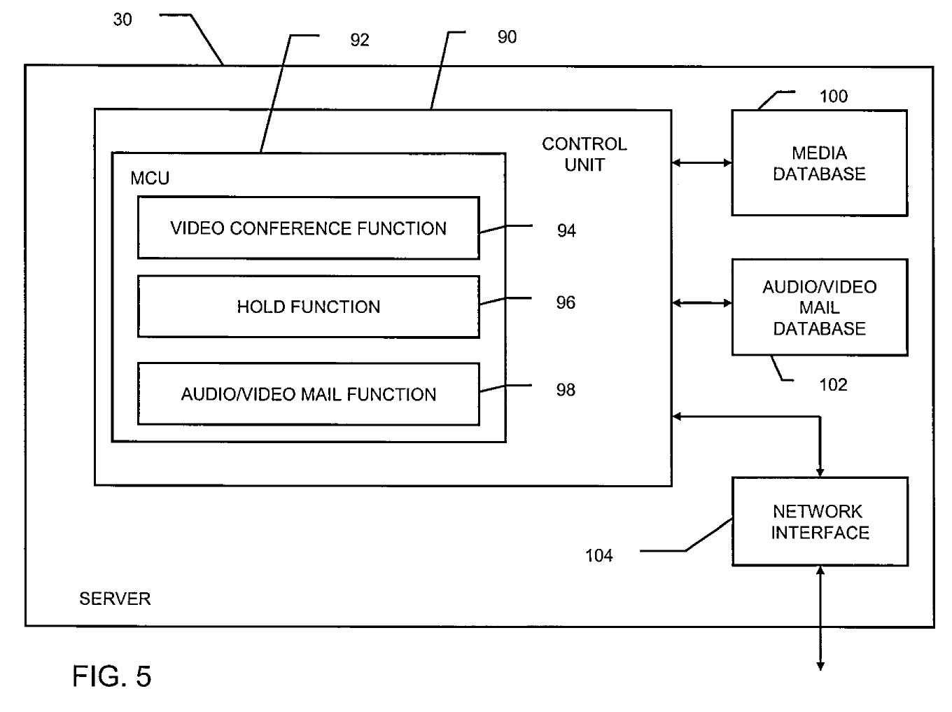

FIG. 5 is an exemplary embodiment of one of the servers 30. A server 30 includes a general control unit 90, that itself may include a master control unit (MCU) 92. The MCU 92 includes hardware, software, firmware, or any combination thereof, for carrying out the herein described video conference function 94, hold function 96 and audio-video mail function 98. The video conference function 94 is conventional and not described in detail herein. The hold function is represented in FIG. 7 discussed below. The audio-video mail function 98 is represented in FIG. 8 discussed below.

A server 30 preferably includes a media database 100 for storing one or more media objects for use in carrying out the hold function 96. The media objects may consist of a library assembled by the service provider, and/or may represent a collection of media objects provided by one or more users of the mobile phones 16 in accordance with the present invention. The media objects may include different songs, advertisements, music videos, personal videos, promotional videos, etc. The users of the service may have uploaded the media objects to the server and the media database 100 in advance. Alternatively, if bandwidth permits the mobile phone 16 may upload the media object(s) to the server 30 at the time of requesting a hold.

The media database 100 in the server 30 may also include different criteria provided to the server from the mobile phone requesting that a call be placed on hold. For example, the media objects associated with a particular user may be stored in the database 100 together with any particular selection criteria commonly utilized by the user. The user may then transmit particular selection criteria requests with the hold request and the MCU 92 can apply the criteria to the media objects within the database 100 to select a particular media object or objects.

The server 30 also preferably includes an audio-video mail database 102 for storing audio-video mail as discussed in more detail below with respect to FIG. 8. Moreover, the server 30 includes an interface 104 for connecting the server 30 to the communications network 10 as is conventional.

Turning now to FIG. 6, the process of carrying out a hold function from the perspective of a user's mobile phone 16 in accordance with the present invention will now be described. Initially, it is assumed that the user is engaged in a call between the user's mobile phone 16 and one or more called/calling devices. Such standard call or conference call is established using conventional techniques within the network 10. Beginning in step 110, the CPU 50 of the mobile phone 16 (FIG. 3) determines if the user has requested that the call be placed on hold. The CPU 50 may detect whether the user has requested that the call be placed on hold by way of, for example, the user pressing the hold function key 44. If a hold request has not been detected, the CPU 50 will continue to loop around step 110 as shown in FIG. 6.

If the user has requested that the call be placed on hold as determined in step 110, the process proceeds to step 112. In step 112, the CPU 50 determines if the user has selected a particular hold criteria as discussed above. Again, for example, the user may request that the particular media object to be communicated to the called/calling devices be based on the identity of the called/calling parties. If the user has selected particular hold criteria as determined in step 112, the CPU 50 proceeds to step 114 in which the CPU 50 determines the particular hold criteria most recently selected by the user. Next, in step 116 the CPU 50 causes the mobile phone 16 to transmit a hold request to the appropriate server 30 within the communications network 10 together with the particular hold criteria. Typically this will be via the radio circuit 66 to the service provider 12, and thereon within the communications network 10 as necessary. The appropriate server 30 may be determined based on conventional network protocol such as distance away, server workload, etc. In addition, in step 116 the CPU 50 stops transmitting audio and video from the mobile phone 16 (e.g., via the microphone 70 and cameral 78) to the called/calling devices.

Preferably, the server 30 is part of a server already serving as part of the communications link for the ongoing call. Consequently, a connection with the called/calling devices will have already been established and a separate connection need not be obtained in order for the server 30 to communicate the media object to the called/calling devices in place of the audio and/or video that ordinary would be communicated from the user's mobile phone 16. Otherwise, the server 30 preferably is configured to establish a connection with the called/calling devices in order to transfer the media object. In such case, however, it may be necessary to modify a conventional mobile phone at the called/calling end to receive the media object without disruption of the current connection on which the call has been placed on hold.

If in step 112 the CPU 50 determines that the user has not selected any particular hold criteria, the mobile phone 16 transmits the hold request to the appropriate server 30 without any particular hold criteria. The server 30 may then draw from the media database a default media object associated with the user and communicate the media object to the called/calling devices at the other end of the call.

In step 118, the CPU 50 determines if the user has requested that the call be taken off hold. If no, the CPU 50 continues to loop around step 118 and the server 30 continues to communicate the media object(s) to the called/calling devices. Whether the user has requested that the call be taken off hold can again be determined based on the user pressing the hold function key 44 a second time, for example. Upon detecting that the user has requested that the call be taken off hold, the CPU 50 proceeds to step 120 in which the CPU 50 transmits an end hold request to the server 30 responsible for communicating the media object to the called/calling devices. In response, the server 30 stops communicating the media object. The CPU 50 causes the mobile phone 16 to return to conventional operation whereby audio and video from the mobile phone 16 continues to be transmitted to the called/calling devices as in a conventional call. In addition, the CPU 50 returns to step 110.

FIG. 7 illustrates the operation of the server 30 in conjunction with carrying out the hold function in accordance with the present invention. Again, it is assumed that a call between the user's mobile phone 16 and the called/calling devices has already been established. It is also assumed that the server 30 is part of a server already part of the connection forming the call between the user's mobile phone and the called/calling devices as discussed above. Thus, beginning in step 124 the MCU 92 of the server 30 (FIG. 5) functions simply to route the typical audio and/or video between the user's mobile phone 16 and the called/calling devices. Next, in step 126 the MCU 92 determines if a hold request has been received as a result of step 116 in FIG. 6. If no, the MCU 92 loops back to step 124 as shown.

If yes in step 126, the MCU 92 proceeds to step 128 in which the MCU 92 selects an appropriate media object(s) based on the hold request and any criteria contained therewith received in step 126. As previously described, preferably the MCU 92 acquires the media object from the media database 100 in accordance with any prescribed criteria. The MCU 92 then proceeds to transmit the audio and/or video to the called/calling devices in place of the audio and/or video from the user's mobile phone 18 as represented in step 130. The MCU 92 can transmit the media object in any suitable manner. For example, in the case of video it is preferable to stream the audio and video data to the called/calling devices to reduce bandwidth requirements. Alternatively, if the bandwidth is available the server 30 may simply reproduce the audio and/or video and feed it to the called/calling devices in real time in place of the audio and/or video from the user's mobile phone 16.

In step 132 the MCU 92 determines if the server 30 has received an end hold request as a result of step 120 in FIG. 6. If not, the MCU 92 continues to loop through steps 130 and 132. Upon receiving an end hold request as determined in step 132, the MCU stops communicating the media object to the called/calling devices and returns to step 124. As a result, normal call communications may resume.

FIG. 8 illustrates the operation of the audio-video mail function of the present invention. In such case, the server 30 provides mail service functions as noted above. Specifically, using conventional voicemail techniques the server 30 determines if a user's mobile phone 18 is unavailable and, if so, is configured to transfer the call of a calling device into the server mail function. Thus, the server 30 in step 140 determines if an incoming call to the user's mobile phone 18 has been received into the mail function 98 (FIG. 5). If yes, the MCU 92 in step 142 proceeds to communicate an audio and/or video mail greeting to the calling device and invites the caller to leave a message. Next, in step 144 the MCU 92 determines if the calling device has left a message. For example, the MCU 92 determines if the connection has been lost (e.g., the caller hung up) or if there is no audio or video being received. If an audio or video response is received as determined in step 144, the MCU 92 stores the audio-video mail message into the audio-video mail database 102 as represented in step 146. If, in step 140, a call is not received, the MCU 92 continues to loop through step 140.

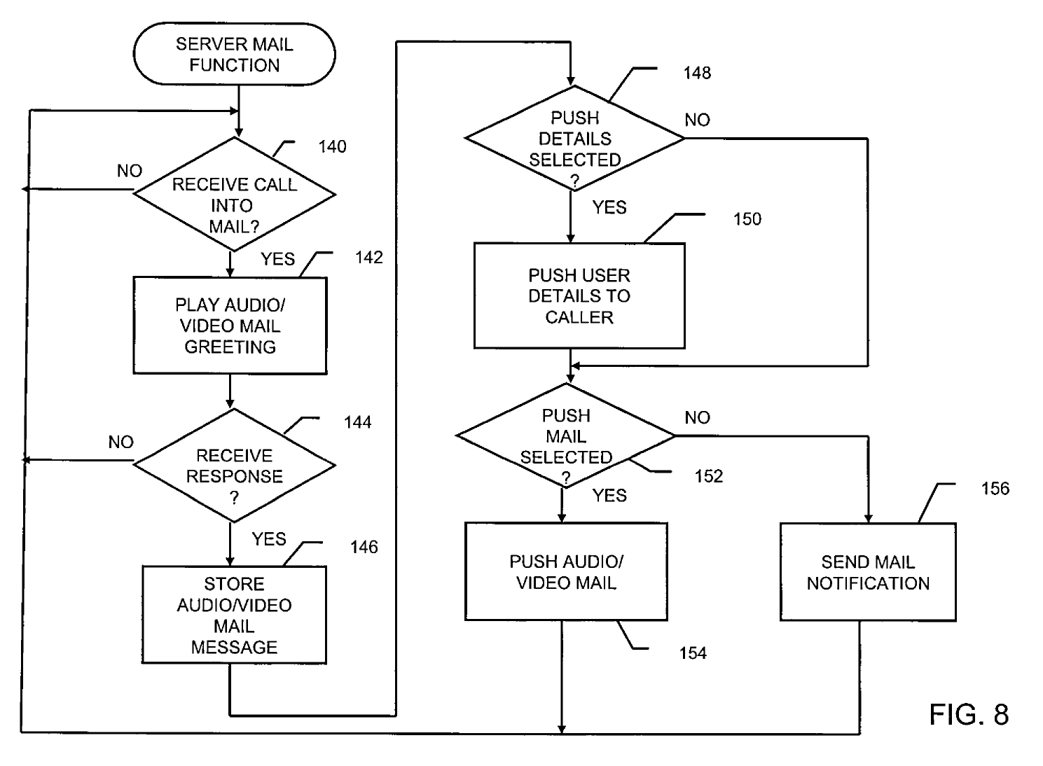

Following step 146, the MCU 92 in step 148 determines if the user of the mobile phone 18 has chosen to have details about the user pushed back to the calling device in accordance with the present invention. As described below in connection with FIGS. 9A-9C, the user may select to have the server 30 transmit information relating to the user (e.g., user contact details, availability information, etc.) in response to the server 30 receiving audio-video mail for the mobile phone 18. If the user has requested user details be provided to the calling device, the MCU 92 proceeds to step 150 in which the server 30 retrieves from the audio/video mail database 102 user details previously identified by the user of the mobile phone 16 and preferably previously uploaded to the server 30. The server 30 then proceeds to push the details to the calling device in the form of audio and/or video information. The mechanism for pushing the details to the calling device may be conventional techniques now commonly associated with various email platforms for use with mobile phones. If in step 148 the user of the mobile phone 16 has not selected for details to be pushed to the caller, the MCU 92 skips step 150 as shown in FIG. 8.

Following steps 148 and/or 150, the MCU 92 proceeds to step 152 in which the MCU 92 determines whether the user of the mobile phone 16 has previously requested that audio-video mail be pushed out to the user's mobile phone 16. If yes, the MCU 92 proceeds to step 154 in which the MCU 92 causes the server 30 to push the audio-video mail left by the calling device in step 146 out to the user's mobile phone 16. Again, the mechanism for pushing the details to the calling device may be conventional techniques now commonly associated with various email platforms for use with mobile phones. If no in step 152, the MCU 92 may proceed to step 156 instead of step 154 and simply send a mail notification to the user's mobile phone 16 as is typical with standard voicemail with mobile phones. Following step 154 or step 156, the MCU 92 returns to step 140 as shown in FIG. 8.

FIGS. 9A, 9B and 9C illustrate an exemplary interface presented on the display 34 of the user's mobile phone 16 for permitting a user to select audio-video mail functions, etc. in accordance with the embodiment of FIG. 8. Again, by stepping through appropriately labeled menus the user may select desired user details, whether the user details are to be pushed to the calling device via the server 30, whether the received mail is to be pushed to the mobile phone 16, etc. Preferably, each time the user changes the configuration of the phone, the mobile phone 18 transmits the updated configuration information to the server 30 so that the server 30 will already have on record the desired user settings, as will be appreciated.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A server for providing call hold functions to a communications network through which a call between a user electronic equipment and one or more called/calling devices is routed, the server comprising:
a network interface that connects the server to the communications network; and
a controller that is coupled to the communications network via the network interface, the controller being operatively configured to communicate a media object to at least one of the one or more called/calling devices in response to the user electronic equipment placing the call on hold.

2. The server of claim 1, wherein the controller is operatively configured to communicate the media object to the at least one of the one or more called/calling devices using a same network connection within the communications network upon which the call has been established.

3. The server of claim 1, wherein the controller is operatively configured to stop communicating the media object in response to the user electronic equipment having taken the call off hold.

4. The server of claim 1, wherein the controller is operative to stream the media object.

5. The server of claim 1, wherein the controller is operative to reproduces the media object as an audio signal when communicating the media object.

6. The server of claim 1, further comprising a library of media objects, and the controller enables a user of the user electronic equipment to select from the library the communicated media object.

7. The server of claim 1, further comprising a library of media objects, and the controller communicates the media object selected from among the library of media objects as a function of an identity of the called/calling device to which the media object is communicated.

8. The server of claim 1, further comprising a library of media objects, and the controller communicates the media object selected generally randomly from among the library of media objects.

9. The server of claim 1, wherein the media object comprises an audio object.

10. The server of claim 1, wherein the media object comprises a visual object.

11. The server of claim 1, wherein the media object represents an advertisement.

12. The server of claim 1, wherein the controller is further configured to provide conference call functions with respect to the call between a user electronic equipment and one or more called/calling devices.

13. The server of claim 12, wherein the controller communicates the media object to each of the one or more called/calling devices participating in the conference call.

14. The server of claim 1, wherein the controller communicates the media object to the at least one of the one or more called/calling devices in response to receiving a request from the user electronic equipment indicating that the call has been placed on hold.

15. The server of claim 14, wherein the request includes criteria based upon which the controller determines the media object to communicate among a library of media objects.

16. A user electronic equipment designed for use in combination with a server as recited in claim 1, the user electronic equipment comprising:
call circuitry that enables the user electronic equipment to establish a call with a called/calling device;
hold circuitry that enables the user electronic equipment to place the call established with the called/calling device on hold; and
a controller operative in conjunction with the call circuitry and hold circuitry to communicate a request to the server indicating that the call is placed on hold.

17. The server of claim 16, wherein the request includes criteria based upon which the controller determines the media object to communicate among a library of media objects.

18. A server for providing audio-video voicemail functions to a communications network through which a call between a user electronic equipment and a calling device is routed, the server comprising:
a network interface that connects the server to the communications network; and
a controller that is coupled to the communications network via the network interface, the controller being operatively configured to receive audio-video mail from the calling device when the user electronic equipment does not answer the call.

19. The server of claim 18, wherein the controller is operatively configured to push user details to the calling device in addition to receiving the audio-video mail.

20. The server of claim 18, wherein the controller is operatively configured to push the audio-video mail to the user electronic equipment.
